(19) United States
(12) Patent Application Publication
(10) Pub. No.: US 2009/0097240 A1
(43) Pub. Date: Apr. 16, 2009

(54) Spread illuminating apparatus

(75) Inventor: Motoji Egawa, Kitasaku-gun (JP)

Correspondence Address: OLIFF & BERRIDGE, PLC, P.O. BOX 320850, ALEXANDRIA, VA, 22320-4850, US

(73) Assignee: MINEBEA CO., LTD., KITASAKU-GUN (JP)

(21) Appl. No.: 12/285,287

(22) Filed: Oct. 1, 2008

(30) Foreign Application Priority Data
Oct. 16, 2007 (JP) 2007-268486

(51) Int. Cl. F21V 9/00

(52) U.S. Cl. 362/231

(57) ABSTRACT

A spread illuminating apparatus is provided in which a light source assembly disposed at one side surface of a light guide plate includes red LEDs, green LEDs and blue white LEDs. The blue white LEDs each include a blue LED and a yellow phosphor and are adapted to emit a red component light and a green component light as well as a blue light. The blue white LED functions not only as a light source for blue light but also as a light source for red and green lights, whereby the numbers of the red LEDs, the green LEDs and the blue white LEDs are equalized. All the LEDs are arranged along the one side surface of the light guide plate at substantially regular intervals. Color heterogeneity generated when a plurality of kinds of LEDs are used is reduced, and thereby an area required for mixing colors is reduced.

### BACKGROUND OF THE INVENTION

1. Field of the Invention

The present invention relates to a spread illuminating apparatus incorporating a plurality of kinds of LEDs (light emitting diodes) emitting respective different colors of light, and particularly to a spread illuminating apparatus suitable for a backlight for use in a liquid crystal display panel.

2. Description of the Related Art

A liquid crystal display (LCD) panel characterized in having a small thickness does not emit light by itself and therefore needs an illuminating means for displaying images. The illuminating means fall into two major types; a spread illuminating apparatus of side light type in which a light source is disposed at a side surface of a light guide plate disposed under an LCD panel, and a spread illuminating apparatus of direct light type in which a light source is disposed under an LCD in a planar manner.

In the spread illuminating apparatus of side light type, an LED, which is superior in terms of power saving and environment resistance, is relatively often used. Meanwhile, in the spread illuminating apparatus of direct light type, a line light such as a cold cathode fluorescent lamp has conventionally been used mainly, but recently an LED is used probatively because of easy illumination area control.

In order to match a spread illuminating apparatus with the full color presentation of an LCD panel, a white color light source must be used as a light source. A white LED (pseudo-white LED) composed of a combination of a blue LED and a yellow phosphor is widely used as an LED light source to emit a white color light (refer to, for example, Japanese Patent Application Laid-Open No. H10-242513). Also, recently, an RGB-LED (three-wavelength white LED) composed of a combination of a red (R) LED, a green (G) LED and a blue (B) LED is receiving attention in terms of color reproducibility (refer to, for example, Japanese Patent Application Laid-Open No. 2006-339047).

The white LED composed of a blue LED in combination with a yellow phosphor has a high luminous efficiency but has a low color reproducibility. On the other hand, the RGB-LED has a high color reproducibility but has a low luminous efficiency. Also, since the RGB-LED produces a white color light by mixing the three primary colors (red, green and blue) of lights emitted from the three kinds of monochromatic LEDs, color heterogeneity is generated in the neighborhood of the light source wherein the size of the heterogeneity depends on a distance between two adjacent LEDs of the three monochromatic LEDs.

Further, in order to achieve a white color light close to the sunlight from the RGB-LED, the radiant flux ratio of red, green and blue lights must be set at about 3:7:1. This means, for example, that the radiant flux of red light is set at about 3/7 of the radiant flux of green light. In this connection, since a red LED inherently has a large wavelength shift due to temperature change and also is likely to suffer an increase of defects of crystals to make up an LED chip when a relatively large current is applied, the radiant flux per element of a red LED must be set smaller than that of a green LED. Consequently, the number of red LEDs is substantially equal to the number of green LEDs. Meanwhile, the radiant flux of blue light is set at about 1/7 of the radiant flux of green light. In this connection, since the blue LED uses the same crystal system as the green LED, the radiant flux per element of both blue and green LEDs can be set equal to each other. If the radiant flux per element of blue and green LEDs is set to equal to each other, the number of blue LEDs is only about 1/7 of the number of green LEDs. Accordingly, the distance between two adjacent blue LEDs arranged is about seven times as large as the distance between two adjacent green LEDs arranged. Thus, the distance between two adjacent blue LEDs is larger than the distance between two adjacent green LEDs and also between two adjacent red LEDs, whereby color heterogeneity is generated in a relatively wide area close to the light source (such color heterogeneity is hereinafter referred to as “color heterogeneity due to sparse blue light” for convenience sake).

In order to eliminate the effect of the color heterogeneity on an illumination light, a spread illuminating apparatus must have a non-effective area (dead area) corresponding to a distance (color mixing distance) required for fully mixing the three primary colors to thereby produce a uniform white color light. The larger area the color heterogeneity extends over, the larger dead area the spread illuminating apparatus must have, thus increasing the size of the spread illuminating apparatus. This results in running counter to the demand that the apparatus be downsized. In this connection, the distance between two adjacent blue LEDs may be decreased by decreasing the radiant flux per element thereby increasing the number of the LEDs used for the purpose of eliminating the color heterogeneity due to sparse blue light, but this increases the cost of components thus proving impractical. Consequently, the spread illuminating apparatus using the RGB-LED as a light source, while providing a good color reproducibility, has a large color heterogeneity (that is to say, color non-uniform is recognized in a large area) and therefore must secure a long color mixing distance.

### SUMMARY OF THE INVENTION

The present invention has been made in light of the above problem, and it is an object of the present invention to provide a spread illuminating apparatus which, regardless of side light type or direct light type, has a high efficiency, gives a good color reproducibility, and which requires a short color mixing distance thus allowing downsizing.

In order to achieve the object described above, according to an aspect of the present invention, there is provided a spread illuminating apparatus which includes a light source assembly including a plurality of kinds of LEDs for emitting respective different color lights, the apparatus adapted to illuminate an image display panel, characterized in that the light source assembly includes in combination a plurality of red LEDs to emit red lights, a plurality of green LEDs to emit green lights, and a plurality of blue white LEDs each including a blue LED and a phosphor and adapted to emit blue lights mainly and to emit red and green lights in a subsidiary manner.

In the aspect of the present invention, the emission chromaticity of the blue white LED may satisfy: 0.15≦x≦0.27, and 0.15≦y≦0.27 in a CIE chromaticity diagram.

In the aspect of the present invention, the light source assembly may include substantially equal numbers of the red LEDs, the green LEDs and the blue white LEDs.

In the aspect of the present invention, the light source assembly may be structured such that a plurality of light source units each including the red LED, the green LED and the blue white LED are disposed in one dimensional direction at substantially regular intervals.

In the aspect of the present invention, the light source assembly may be disposed along at least one side surface of a light guide plate disposed at the bottom of the image display panel.

In the aspect of the present invention, the light source assembly may be structured such that a plurality of light source units each including the red LED, the green LED and the blue white LED are disposed in two dimensional directions at regular intervals, and wherein the light source assembly is disposed at the bottom of the image display panel.

In the aspect of the present invention, the light source unit may be structured such that the red LED, the green LED and the blue white LED are arranged in an adjacent manner.

In the aspect of the present invention, respective electric powers supplied to the red LED, the green LED and the blue white LED may be dynamically controlled individually in synchronization with color information of three primary colors of an image displayed in the image display panel.

The spread illuminating apparatus described above, regardless of side light type or direct light type, has a high efficiency, gives a good color reproducibility, and requires a short color mixing distance thus allowing downsizing.

### BRIEF DESCRIPTION OF THE DRAWINGS

FIG. 1 is a schematic top plan view of a spread illuminating apparatus of side light type according to a first embodiment of the present invention;

FIG. 2 is a graph of examples of emission spectroscopic characterizations of a red LED, a green LED and a blue white LED of a light source assembly of the present invention;

FIG. 3 is a schematic cross sectional view of an example of the blue white LED of the present invention;

FIG. 4 is a graph of a comparison of an example of the emission spectroscopic characterization of the blue white LED of the present invention with emission spectroscopic characterizations of conventional white and blue LEDs; and

FIG. 5 is a schematic top plan view of a spread illuminating apparatus of direct light type according to a second embodiment of the present invention.

### DETAILED DESCRIPTION OF THE INVENTION

Exemplary embodiments of the present invention will be described with reference to the accompanying drawings.

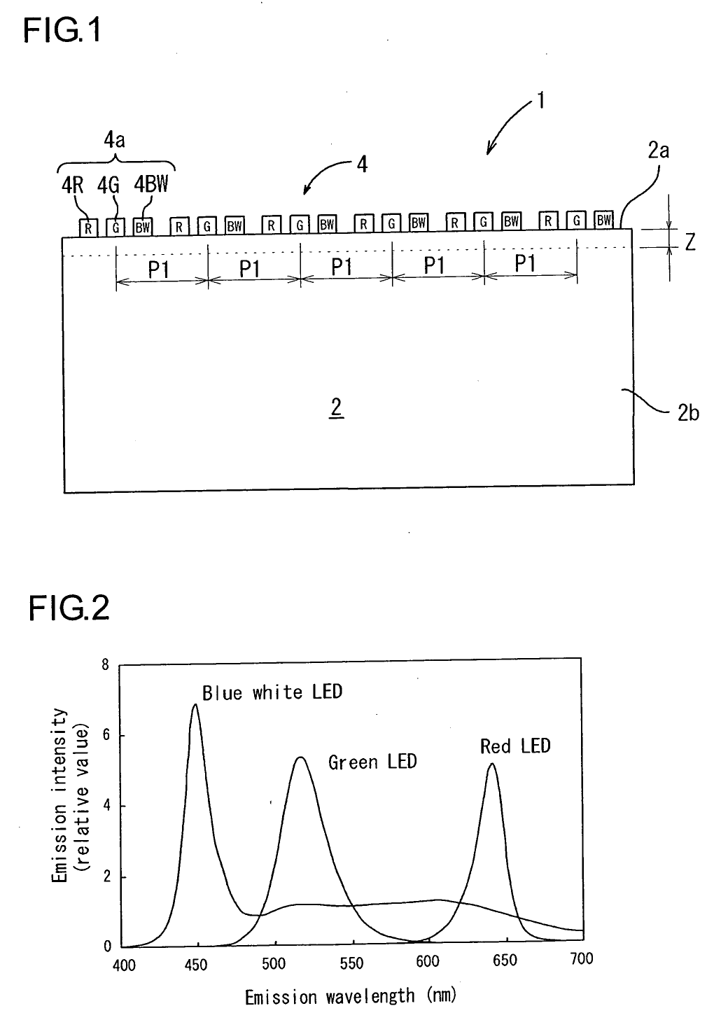

A spread illuminating apparatus according to a first embodiment of the present invention will be described with reference to FIGS. 1 to 4.

Referring to FIG. 1, a spread illuminating apparatus 1 according to the first embodiment of the present invention is of side light type and includes a light guide plate 2 disposed under an image display panel as an illuminated body (for example, LCD panel), and a light source assembly 4 disposed (in one dimensional direction) along one side surface (light entrance surface) 2a of the light guide plate 2. The light source assembly 4 is mounted on a circuit board not shown.

The light guide plate 2 is a transparent plate having a substantially rectangular shape. A prism (not shown) adapted to control the spread angle of lights emitted from the light source assembly 4 is formed on the one side surface 2a of the light guide plate 2. Also, an optical path converting means (not shown) to scatter lights emitted from the light source assembly 4 and introduced in the light guide plate 2 is formed on the bottom surface (rear surface) of the light guide plate 2. Further, a reflector (not shown) to reintroduce into the light guide plate 2 lights leaking from the bottom surface of the light guide plate 2 is disposed at the bottom surface of the light guide plate 2. And, optical sheets (not shown), such as a light diffusing sheet to uniformize lights emitted from the top surface (front surface) of the light guide plate 2 and a prism sheet to control directivity characteristics of the lights, are provided as appropriate at the top surface of the light guide plate 2.

The light source assembly 4 includes a plurality of red LEDs 4R, a plurality of green LEDs 4G and a plurality of blue white LEDs 4BW. In the example shown in FIG. 1, the light source assembly 4 is made up of a plurality of light source units 4a which are arrayed at a prescribed regular pitch P1 along the one side surface 2a of the light guide plate 2 and each of which is composed of three kinds of LEDs such that one red LED 4R, one green LED 4G and one blue white LED 4BW are arrayed at predetermined intervals with a space disposed therebetween. On the whole, the three kinds of LEDs 4R, 4G and 4BW are disposed in an alternate manner, wherein the LEDs of one kind are arrayed regularly at the pitch P1. Also, the numbers of the three kinds of LEDs are equal to one another.

The red LED 4R is a monochromatic LED having an emission central wavelength ranging between 600 nm and 680 nm as presented by the emission spectroscopic characterization (the horizontal axis indicates emission wavelength, and the vertical axis indicates emission intensity) shown in FIG. 2. Also, as shown in FIG. 2, the green LED 4G is a monochromatic LED having an emission central wavelength ranging between 500 nm and 580 nm.

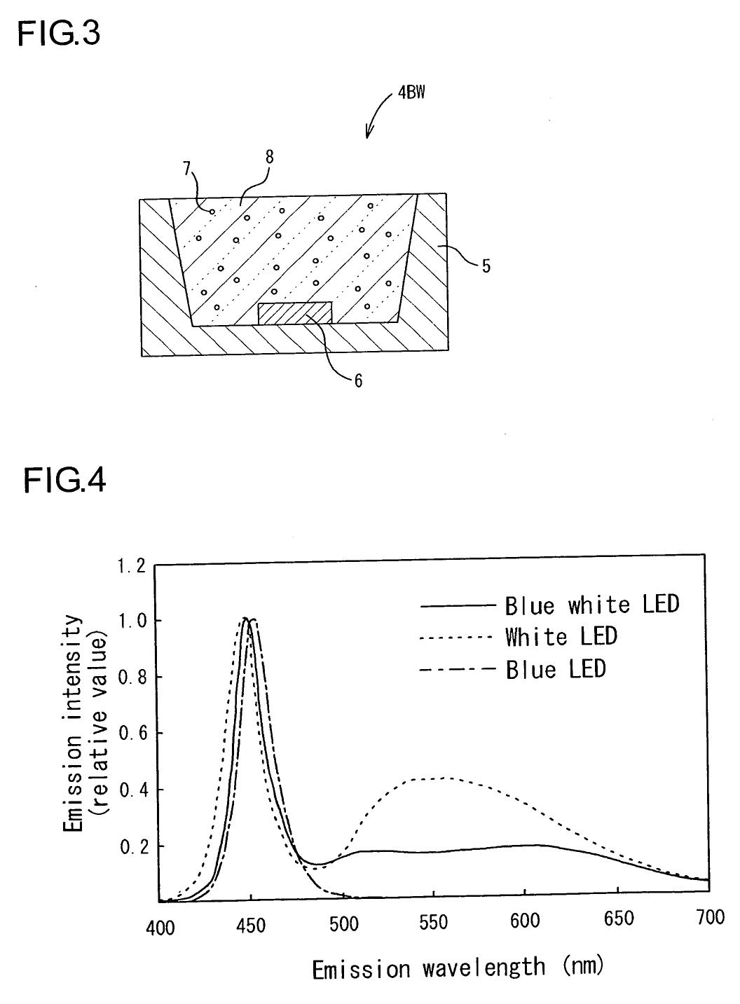

Detailed description will now be made on the blue white LED 4BW. Referring to FIG. 3, the blue white LED 4BW includes, for example, a package 5 having a box shape and adapted to reflect light, a blue LED chip 6 mounted on the bottom portion of the package 5, and a mold member 8 having a phosphor 7 dispersedly contained therein. The package 5 is made of, for example, white resin. The blue LED chip 6 is a monochromatic LED having an emission central wavelength ranging between 410 nm and 480 nm. The phosphor 7 is, for example, yttrium aluminum garnet (yellow phosphor) activated by Ce and adapted to emit, upon receipt of blue light emitted from the blue LED chip 6, light having a wavelength ranging from about 480 nm to 700 nm. The mold member 8 is, for example, silicone resin having translucency. The mold member 8 may have diffusing particles such as titanium oxide dispersedly contained therein.

The blue white LED 4BW is common to the conventional white LED (pseudo white LED) in including a blue LED and a yellow phosphor but differs therefrom in that the amount of the phosphor (the amount of the phosphor 7 dispersedly contained in the mold member 8) is reduced within a certain range. Specifically, the amount of the phosphor included in the blue white LED 4BW is adjusted so that the emission chromaticity of light emitted from the blue white LED 4BW establishes: 0.15≦x≦0.27, and 0.15≦y≦0.27 in the CIE (International Commission on Illumination) chromaticity diagram. The above numerical values represent a preferable chromaticity range of the blue white LED 4BW according to the present invention.

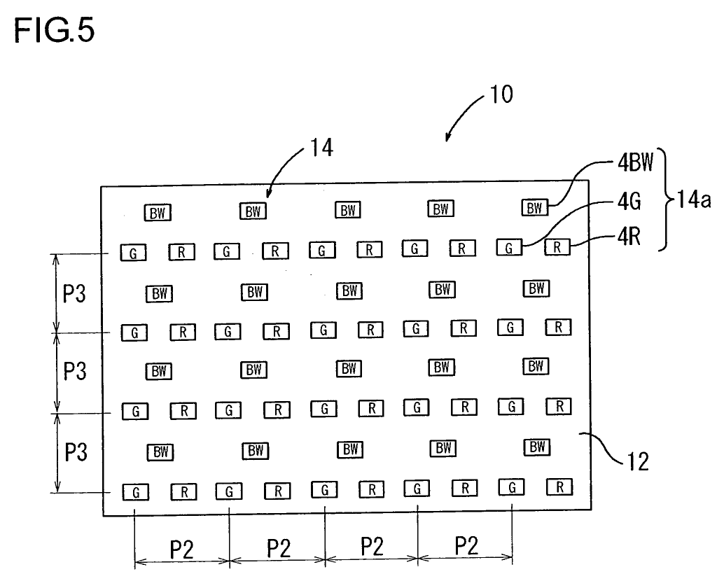

FIG. 4 shows an example of the emission spectroscopic characterization of the blue white LED 4BW in comparison with the emission spectroscopic characterizations of a general white LED and a general blue LED. In the CIE chromaticity diagram of the blue white LED 4BW in FIG. 4, the values of x and y are 0.267 and 0.222, respectively. The blue white LED 4BW is common to the white LED in having a main peak at a wavelength of 450 nm and also in emitting light of wavelength ranging from about 400 nm to 700 nm. Meanwhile, the blue white LED 4BW has a lower emission intensity in the green color band (wavelength ranging from 500 nm to 580 nm) and the red color band (wavelength ranging from 600 nm to 660 nm) than the white LED. Also, in FIG. 4, the emission spectroscopic characterization of the three LEDs are normalized to the emission intensity of blue color (wavelength of 450 nm) and therefore the blue white LED 4BW has a higher emission intensity in the blue color band than the white LED, though this cannot be observed straightforwardly in FIG. 4. On the other hand, the blue white LED 4BW differs from the blue LED in emitting light also in the green light band and the red light band while it has a lower emission intensity in the blue color band than the blue LED. That is to say, the blue white LED 4BW functions as a blue monochromatic light source in a pseudo manner to mainly emit a blue light and also as an auxiliary light source to light red and green lights in a subsidiary manner.

The spread illuminating apparatus 1 described above according to the first embodiment provides the following advantages.

In the spread illuminating apparatus 1, the respective color lights emitted from the light source assembly 4 are introduced into the light guide plate 2 from the light entrance surface 2a of the light guide plate 2 and are uniformly emitted from the top surface of the light guide plate 2 while traveling in the light guide plate 2, whereby the image display panel disposed at the top surface of the light guide plate 2 is illuminated. In this connection, the respective color lights introduced into the light guide plate 2 are scattered by the optical path converting means formed on the bottom surface of the light guide plate 2 and are thereby mixed together.

With the above-described structure of the light source assembly 4, the prescribed amount (radiant flux) of blue light of the three primary colors is totally obtained by lighting the blue white LED 4BW, a part of the prescribed amount of red light of the three primary colors is obtained by lighting the blue white LED 4BW while the remaining part of the prescribed amount thereof is obtained by lighting the red LED 4R, and a part of the prescribed amount of green light of the three primary colors is obtained by lighting the blue white LED 4BW while the remaining part of the prescribed amount thereof is obtained by lighting the green LED 4G.

Thus, in the light source assembly 4 the blue white LED 4BW is adapted to function as a light source for red and green colors, and consequently the numbers of the red LEDs 4R and the green LEDs 4G are reduced compared with a conventional light source structure constituted by an RGB-LED in which the number of red/green LEDs is greater than the number of blue LEDs. Also, since the amount of blue light emitted per element is smaller in the blue white LED 4BW than in the blue LED of the RGB-LED, the number of the blue white LEDs 4BW in the light source assembly 4 is greater than the number of the blue LEDs in the conventional RGB-LED light source structure. For the reasons described above, the difference in the numbers of the three kinds of LEDs used in the light source assembly 4 is smaller than that in the conventional RGB-LED light source structure. That is to say, the numbers of the three kinds of LEDs are equalized. As a result, in the spread illuminating apparatus 1 incorporating the light source assembly 4, the color heterogeneity due to sparse blue light is reduced. Also, since the red LED 4R, the green LED 4G and the blue white LED 4BW function as respective color monochromatic light sources for the three primary colors (red, green and blue), the spread illuminating apparatus 1 achieves a good color reproducibility. Further, since the blue white LED 4BW is a combination of a blue LED and a phosphor, the light source assembly 4 has a good luminous efficiency.

Further, the numbers of the three kinds of LEDs can be equalized at a higher level by finely adjusting the amount of the phosphor, the drive currents for the three kinds of LEDs, and the light emitting areas of the LED chips thereby precisely controlling the radiant fluxes of the three kinds of LEDs. This enables that the numbers of the three kinds of LEDs can be substantially equalized with a difference of 10% or less. As a result, the color heterogeneity due to sparse blue light can be further reduced. With the reduction of the color heterogeneity, the color mixing distance (corresponding to the dead area Z in FIG. 1) is decreased, and therefore a narrow-framed spread illuminating apparatus can be achieved.

The disposition of the three kinds of LEDs to constitute the light source unit 4a is not limited to the arrangement described above, but, for example, the three kinds (red, green and blue white) of LEDs may be disposed in contact with each other. Even when the light source unit 4a is structured in this way, the color heterogeneity due to sparse blue light can be reduced. This contact arrangement of the three kinds of LEDs also reduces color heterogeneity which is caused when the three kinds of LEDs are arranged with a space disposed therebetween. Further, with the contact arrangement of the three kinds of LEDs to constitute the light source unit 4a, the light source unit 4a can be easily formed into a package. As a result, the circuit wiring can be easily installed thus enhancing the productivity of the apparatus. Also, the interval between two adjacent LEDs of the light source unit 4a may be set equal to the interval between two adjacent light source units 4a, whereby all the intervals between any two adjacent LEDs are equal to one another. In this case, since all the LEDs can be arrayed evenly, it is prevented that heats from the LEDs are focused on one area. Also, the array order of the three kinds of LEDs for the light source unit 4a is not limited to the embodiment described above. For example, the blue white LED 4BW may be disposed between the red LED 4R and the green LED 4G. And, the light source assembly 4 may be disposed at a plurality of side surfaces of the light guide plate 2.

A spread illuminating apparatus according to a second embodiment of the present invention will be described with reference to FIG. 5. In explaining the second embodiment, any component parts corresponding to those in the preceding drawings are denoted by the same reference numerals, and a redundant description thereof will be omitted below. Referring to FIG. 5, a spread illuminating apparatus 10 according to the second embodiment of the present invention is of direct light type, disposed under an image display panel as an illuminated body (for example, LCD panel), and includes a base plate 12 having a substantially rectangular shape and a light source assembly 14 disposed on the base plate 12. And, optical sheets (not shown), such as a light diffusing sheet to uniformize lights emitted from the light source assembly 14 and a prism sheet to control directivity characteristics of the lights, are provided as appropriate toward the emission direction of the light source assembly 14.

The base plate 12 has the light source assembly 14 mounted thereon and functions as a circuit board to supply electric power to the light source assembly 14. In order for the base plate 12 to have a light reflecting function, for example, white coating may be applied to a surface of the base plate 12, the surface having the light source assembly 14 mounted thereon.

The light source assembly 14 is composed of three kinds of LEDs; a plurality of red LEDs 4R, a plurality of green LEDs 4G, and a plurality of blue white LEDS 4BW in the same way as in the first embodiment. More specifically, in an example shown in FIG. 5, the light source assembly 14 is composed of a plurality of light source units 14a, each of which is structured such that one red LED 4R, one green LED 4G and one blue white LED 4BW are each disposed on each of three vertices of a virtual triangle, and which are arranged in two dimensional directions at regular intervals. Thus, on the whole, the three kinds of LEDs are arranged in two dimensional directions at regular intervals. In the above example of FIG. 5, the interval in one direction (horizontally in the figure) is indicated by P2, and the interval in another direction (vertically in the figure) is indicated by P3. The numbers of the three kinds of LEDs are identical with one another.

In the second embodiment, too, the numbers of the three kinds of LEDs are equalized for the reason explained with respect to the first embodiment. As a result, the color heterogeneity due to sparse blue light, which is generated close (with respect to the direction perpendicular to the surface of the base plate 12) to the light source assembly 14, is reduced. Consequently, the color mixing distance (from the light source assembly 14 to the image display panel disposed toward the light emission direction of the light source assembly 14) can be reduced, whereby the spread illuminating apparatus 10 has a reduced thickness. Also, the haze value of a light diffusing sheet for mixing colors can be reduced thus improving the light use efficiency.

The disposition of the three kinds of LEDs to constitute the light source unit 14a is not limited to the embodiment described above. For example, the three kinds (red, green and blue white) of LEDs may be disposed in contact with each other. Even when the light source unit 4a is structured in this way, the color heterogeneity due to sparse blue light can be reduced. This contact arrangement of the three kinds of LEDs reduces also color heterogeneity which is caused when the three kinds of LEDs are arranged at prescribed intervals with a space disposed therebetween. Further, with the contact arrangement of the three kinds of LEDs, the light source unit 14a can be easily formed into a package. As a result, the circuit wiring can be easily installed thus enhancing the productivity of the apparatus.

The three kinds of LEDs are arranged in two dimensional directions in the embodiment described above, but the three kinds of LEDs according to the present invention may be arranged in one dimensional direction (one row arrangement).

In any spread illuminating apparatuses according to any of the embodiments described above, the three kinds of LEDs may be lit corresponding to an image displayed in the image display panel (for example, LCD panel) as described below. First, currents to drive respective three kinds of LEDs, with the ratio of the drive currents maintained constant, can be dynamically changed corresponding to the peak brightness of image information in synchronization with image brightness information to drive the image display panel. Then, by dynamically adjusting drive voltages for the pixels of three primary colors to constitute the image display panel in accordance with the drive currents for the LEDs, the power consumption can be reduced and also the dynamic contrast is enhanced thereby enabling display of a sharp and crisp image with a deep black tone.

Also, since the light source assembly 4 or 14 according to the present invention includes the three kinds of LEDs which emit respective lights of three primary colors, the radiant fluxes of the three primary colors can be controlled independently of one another by individually changing the drive currents for the three kinds of LEDs. Consequently, the drive currents for the three kinds of LEDs can be dynamically changed individually corresponding to the peak brightness of image information in synchronization with the image color information to drive the image display panel. And, if the drive voltages for the pixels of three primary colors to constitute the image display panel are dynamically adjusted individually in accordance with the drive currents for the LEDs, the power consumption can be reduced and also an image with a good color reproducibility can be displayed. In this connection, when the spread illuminating apparatuses according to the embodiments described above are used as, for example, a backlight for an LCD panel, it is assumed that only a blue light component may be required as an illumination light. In such a case, other light components than the blue light component in the light emitted from the white LED 4BW are blocked by a color filter to constitute the LCD panel, whereby a blue light with a high color purity can be obtained.

Further, in any of the embodiments described above, the red LED 4R may be constituted by a blue LED having an emission central wavelength ranging between 410 nm and 480 nm and a phosphor having an emission central wavelength ranging between 580 nm and 660 nm and excited by the blue LED. Also, the green LED 4G may be constituted by a blue LED having an emission central wavelength ranging between 410 nm and 480 nm and a phosphor having an emission central wavelength ranging between 480 nm and 580 nm and excited by the blue LED. When the red LED 4R and the green LED 4G described above are used for the light source assembly 4 or 14, if the lights emitted from these LEDs are transmitted through, for example, a color filter to constitute the LCD panel, an illumination light with a high color purity can be obtained.

What is claimed is:

1. A spread illuminating apparatus to illuminate an image display panel, the apparatus comprising:
a light source assembly comprising a plurality of kinds of light emitting diodes for emitting respective different color lights, wherein the plurality of kinds of light emitting diodes include a plurality of red LEDs to emit red lights, a plurality of green LEDs to emit green lights, and a plurality of blue white LEDs to emit blue lights mainly and emit red and green lights in a subsidiary manner, the blue white LEDs each comprising in combination a blue LED and a phosphor.

2. A spread illuminating apparatus according to claim 1, wherein an emission chromaticity of the blue white LED satisfies: 0.15≦x≦0.27, and 0.15≦y≦0.27 in a CIE chromaticity diagram.

3. A spread illuminating apparatus according to claim 2, wherein the light source assembly includes substantially equal numbers of the red LEDs, the green LEDs and the blue white LEDs.

4. A spread illuminating apparatus according to claim 3, wherein the light source assembly is structured such that a plurality of light source units each comprising the red LED, the green LED and the blue white LED are disposed in one dimensional direction at substantially regular intervals.

5. A spread illuminating apparatus according to claim 4, wherein the light source assembly is disposed along at least one side surface of a light guide plate disposed at a bottom of the image display panel.

6. A spread illuminating apparatus according to claim 3, wherein the light source assembly is structured such that a plurality of light source units each comprising the red LED, the green LED and the blue white LED are disposed in two dimensional directions at substantially regular intervals, and wherein the light source assembly is disposed at a bottom of the image display panel.

7. A spread illuminating apparatus according to claim 4, wherein the light source unit is structured such that the red LED, the green LED and the blue white LED are arranged in an adjacent manner.

8. A spread illuminating apparatus according to claim 6, wherein the light source unit is structured such that the red LED, the green LED and the blue white LED are arranged in an adjacent manner.

9. A spread illuminating apparatus according to claim 4, wherein respective electric powers supplied to the red LED, the green LED and the blue white LED are dynamically controlled individually in synchronization with color information of three primary colors of an image displayed in the image display panel.

10. A spread illuminating apparatus according to claim 6, wherein respective electric powers supplied to the red LED, the green LED and the blue white LED are dynamically controlled individually in synchronization with color information of three primary colors of an image displayed in the image display panel.
